(19) United States
(12) Patent Application Publication
(10) Pub. No.: US 2024/0303503 A1
(43) Pub. Date: Sep. 12, 2024

(54) SYSTEM AND METHOD FOR DETECTING AN OUT-OF-DISTRIBUTION DATA SAMPLE BASED ON UNCERTAINTY ADVERSARIAL TRAINING

(71) Applicant: Booz Allen Hamilton Inc., McLean, VA (US)

(72) Inventors: Derek Scott Everett, Laurel, MD (US); Andre Tai Nguyen, Columbia, MD (US); Edward Simon Pastor Raff, Jamesville, NY (US)

(73) Assignee: Booz Allen Hamilton Inc., McLean, VA (US)

(21) Appl. No.: 18/485,499

(22) Filed: Oct. 12, 2023

Related U.S. Application Data
(60) Provisional application No. 63/489,470, filed on Mar. 10, 2023.

(51) Int. Cl. G06N 3/094; G06N 3/045; G06N 3/0464

(52) U.S. Cl. CPC G06N 3/094; G06N 3/045; G06N 3/0464

(57) ABSTRACT

Provided are systems, methods, and computer program products including at least one processor programmed or configured to perturb at least one training dataset based on mutual information extracted from an ensemble machine learning model to provide at least one adversarial training dataset, execute at least two machine learning models of an ensemble machine learning model, train at least two machine learning models with the at least one training dataset by feeding an input or output of one of the at least two machine learning models to the other of the at least two machine learning models, train the ensemble machine learning model with the at least one adversarial training dataset, receive a runtime input from a client device, and provide the runtime input to the trained ensemble machine learning model to generate a signal output indicating that the runtime input includes an out-of-distribution sample.

### CROSS-REFERENCE

This U.S. Non-Provisional Application is related to and claims priority to U.S. Provisional Application No. 63/489,470, filed on Mar. 10, 2023, the entire contents of which are incorporated herein by reference.

### FIELD

The subject matter disclosed relates generally to machine learning, and, in some embodiments, to methods, systems, and non-transitory computer readable mediums encoded with program code for automated data processing with a machine learning model configured to detect out-of-distribution (OOD) data. In some embodiments, methods, systems, and non-transitory computer readable mediums may relate to building and/or training a machine learning model for detecting OOD data.

### BACKGROUND INFORMATION

In some instances, uncertainty estimates in machine learning may affect accuracy and/or reliability of machine learning systems in some safety-critical applications. For example, machine learning may be used in the medical field. Such systems may be unable to reject out-of-distribution (OOD) data to send the OOD data back to human experts for review. OOD data and/or OOD samples may include data that is outside of a distribution of data used to train a machine learning model (e.g., training data). That is, OOD data and/or OOD samples may include data that is outside of a training dataset for a machine learning model. In some instances, uncertainty estimates may be used to improve a rate at which a machine learning model is able to detect an OOD sample.

However, prior methods of using uncertainty estimates to improve an OOD detection rate of a machine learning model are ineffective. Prior methods possess high computational costs to incrementally improve a quality of uncertainty estimates. Prior methods are also unable to achieve a real-world applicable constraint of less than or equal to 1% false positive detection rate (FPR). Prior methods fail to reliably detect OOD samples (such as samples containing Gaussian random noise). There is a need for reliable classification performance at low false positive rates (e.g., less than or equal to 1% FPR). Detection of OOD data with machine learning models may be more accurate and meaningful using efficient training techniques and improved uncertainty estimates.

### SUMMARY

Embodiments may relate to methods for automated data processing using a machine learning model configured to detect out-of-distribution (OOD) data. The method may include receiving at least one training dataset. The at least one training dataset may include plural data files. The method may include processing the at least one training datasets with at least two machine learning algorithms executed by a processor to generate at least two machine learning models. The at least two machine learning models may be trained by feeding an input or output of one of the at least two machine learning models to the other of the at least two machine learning models. The at least two machine learning models may form an ensemble machine learning model. The method may include perturbing at least one data file of the at least one training dataset with mutual information extracted from the ensemble machine learning model to provide an adversarial training dataset. The method may include inputting the adversarial training dataset into the ensemble machine learning model to train the ensemble machine learning model. The method may include generating a signal output by causing the processor to execute a trained ensemble machine learning model with a runtime input, wherein the signal output indicates that the runtime input includes an out-of-distribution sample.

Embodiments may relate to systems for automated data processing using a machine learning model configured to detect OOD data. The system may include at least one data storage device configured to store at least one training dataset. The system may include at least one processor programmed or configured to perform various functions. The at least one processor may be programmed or configured to modify at least one training dataset based on mutual information extracted from an ensemble machine learning model to provide at least one adversarial training dataset. The adversarial training dataset may have a modified measure of epistemic uncertainty. The at least one processor may be programmed or configured to execute at least two machine learning models of an ensemble machine learning model. The at least one processor may be programmed or configured to train at least two machine learning models with the at least one training dataset by feeding an input or output of one of the at least two machine learning models to the other of the at least two machine learning models. The at least one processor may be programmed or configured to train the ensemble machine learning model with the at least one adversarial training dataset to provide a trained ensemble machine learning model. The at least one processor may be programmed or configured to receive a runtime input from a client device. The at least one processor may be programmed or configured to provide the runtime input to the trained ensemble machine learning model to generate a signal output indicating that the runtime input to the trained ensemble machine learning model includes an out-of-distribution sample.

Embodiments may relate to non-transitory computer readable media encoded with program code for automated data processing with a machine learning model configured to detect OOD data. When placed in communicable contact with a computer processor, the program code may cause the processor to be configured to perform an operation of receiving at least one training dataset. The at least one training dataset may include plural data files. The program code may cause the processor to be configured to perform an operation of processing the at least one training dataset with at least two machine learning algorithms for generating at least two machine learning models. The at least two machine learning models may be trained by feeding an input or output of one of the at least two machine learning models to the other of the at least two machine learning models to form an ensemble machine learning model. The program code may cause the processor to be configured to perform an operation of perturbing at least one data file of the at least one training dataset with mutual information extracted from the ensemble machine learning model to provide an adversarial training dataset. The program code may cause the processor to be configured to perform an operation of inputting the adversarial training dataset into the ensemble machine learning model to train the ensemble machine learning model. The program code may cause the processor to be configured to perform an operation of generating a signal output by executing a trained ensemble machine learning model with a runtime input, wherein the signal output indicates that the runtime input includes an out-of-distribution sample.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for automated data processing with a machine learning model configured to detect out-of-distribution data as disclosed herein;

FIG. 2 is a flow diagram of an exemplary method for automated data processing with a machine learning model configured to detect out-of-distribution data as disclosed herein;

FIG. 3 is a diagram of an exemplary system environment for automated data processing with a machine learning model configured to detect out-of-distribution data as disclosed herein;

FIGS. 4A-4E are diagrams of an exemplary implementation of a method for automated data processing with a machine learning model configured to detect out-of-distribution samples as disclosed herein; and

FIG. 5 is a diagram of example components of a computing device and/or system as disclosed herein.

### DETAILED DESCRIPTION

In accordance with exemplary embodiments of the present disclosure, machine learning model prediction may be used for the detection of OOD data, OOD samples, and/or data that is outside of a distribution of a training dataset. According to some embodiments, machine learning models (e.g., ensemble machine learning models) may be trained using uncertainty estimates and mutual information predicted and/or generated by an ensemble machine learning model.

Embodiments may detect OOD data with a false positive rate (FPR) of less than or equal to 1% using machine learning models trained using methods disclosed herein. In this way, embodiments of the described methods, systems, and non-transitory computer program products may meet requirements of real-world machine learning systems that have not been previously met by prior art machine learning techniques. Embodiments may involve an adversarial training scheme that incorporates an attack of epistemic uncertainty predicted and/or generated by an ensemble machine learning model using dropout techniques. Embodiments may improve area under a Receiver Operator Characteristic (ROC) curve (AUC) at a maximum false positive rate of 1% (AUC_{FPR<1%}) from near-random guessing performance to greater than or equal to 0.75 on inputs of clean data. Embodiments may simultaneously improve robustness to epistemic uncertainty-targeted attacks.

Embodiments may detect OOD data such as OOD samples including pure Gaussian random noise. Embodiments may more accurately and consistently detect OOD data with the use of a novel uncertainty attack method to improve OOD data detection across various types of samples including fake samples, adversarial samples, and real samples. Embodiments may also use dropout techniques in model training to improve the accuracy of detection of OOD data including clean samples. Embodiments may use a measure of epistemic uncertainty of machine learning models, given by mutual information (e.g., information based on in-distribution training) for ensemble machine learning models, to provide improved detection of OOD data. Embodiments may provide for uncertainty attacks to input and/or training data where the uncertainty attacks perturb the input and/or training data to minimize (or maximize) a predicted and/or generated epistemic uncertainty.

As shown in Table 1, embodiments of the disclosed method outperform methods of the prior art. Table 1 shows maximum false positive rate≤1% scores for each ensemble machine learning model type for data files perturbed using systems and methods as disclosed herein. Scores for the Uncertainty Adversarial Training (UAT) column represent scores that may achieved with methods and systems as disclosed herein. Scores for the Ord., deep ensemble (DE), and label adversarial training (LAT) columns represent prior art methods and systems.

TABLE 1
AUC for a maximum FPR ≤ 1% scores for each ensemble type
for OOD samples attacked using mutual information

| | | AUC_{FPR<1%} | | | |
|---|---|---|---|---|---|
| ID (clean) | OOD (attacked) | Ord. | DE | LAT | UAT |
| MNIST | FMNIST | 0.50 | 0.52 | 0.50 | 0.91 |
| MNIST | Fake | 0.50 | 0.50 | 0.50 | 1.00 |
| FMNIST | MNIST | 0.69 | 0.57 | 0.64 | 0.99 |
| FMNIST | Fake | 0.70 | 0.73 | 0.67 | 1.00 |
| CIFAR10 | SVHN | 0.57 | 0.50 | 0.50 | 0.84 |
| CIFAR10 | Fake | 0.60 | 0.50 | 0.56 | 1.00 |
| SVHN | CIFAR10 | 0.51 | 0.50 | 0.50 | 0.95 |
| SVHN | Fake | 0.55 | 0.50 | 0.51 | 1.00 |
| ImageNet* | Adapt. | 0.50 | NA | 0.50 | 0.53 |
| ImageNet* | Fake | 0.57 | NA | 0.61 | 0.75 |

Table 1 shows that methods and systems disclosed herein produce improved results over prior art methods and systems. Embodiments may result in methods and systems (e.g., machine learning models, processors) that can detect OOD data samples with a false positive rate of less than or equal to 1%, having scores similar to those shown in Table 1 for various types of training datasets and/or input data.

Such embodiments may improve the operation of a processor and/or machine learning models executed by the processor to detect OOD data input to the processor with a lower rate of false positive detections. Such improved operation of a processor and/or machine learning models result in a rate of false positive detections of OOD data that improves upon prior machine learning models and methods.

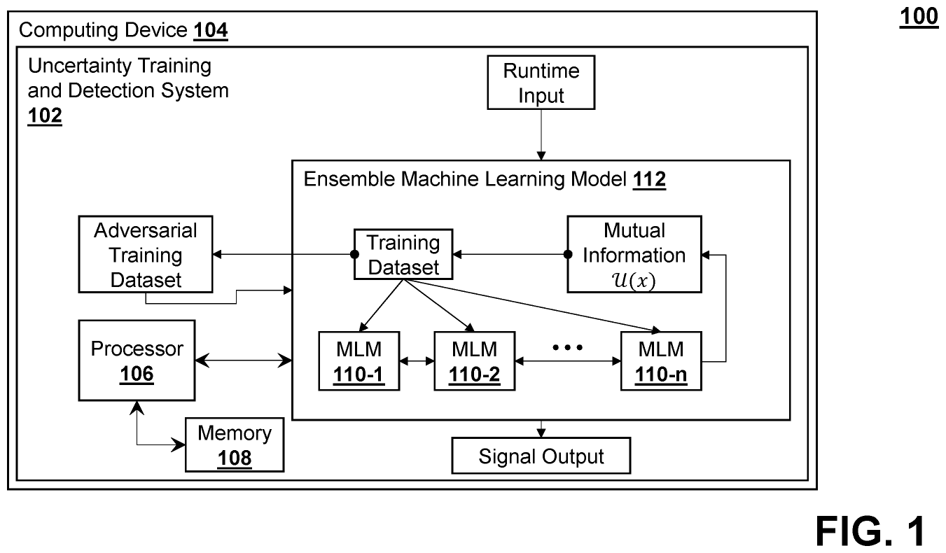

FIG. 1 shows a diagram of an exemplary system configuration 100 operable via program code (e.g., software instructions executed by a processor) for automated data processing with a machine learning model configured to detect out-of-distribution data as disclosed herein. The various components of FIG. 1 may be implemented in and/or processed by a processor (e.g., a central processing unit (CPU)) and/or on any number of distributed processors (e.g., a distributed computing system) coupled with memory and connected via a communications network. Each of the components shown in FIG. 1 are described in the context of an exemplary embodiment.

As shown in FIG. 1, embodiments relate to a system configured for training machine learning models (e.g., neural models, neural networks, and/or the like) and for detecting OOD data (e.g., OOD samples) with trained machine learning models. In some embodiments, the system may be configured for automated data processing by executing at least one machine learning model configured to detect OOD data samples. System configuration 100 may include uncertainty training and detection system 102, computing device 104, processor 106, memory 108, ensemble machine learning model 112, and at least two machine learning models (MLM) 110-1 to 110-n (referred to individually as MLM 110 and collectively as plurality of MLMs 110).

A system configured for automated data processing, that executes a machine learning model configured to detect OOD samples, may include at least one data storage device configured to store at least one training dataset. For example, uncertainty training and detection system 102 may include a system configured for automated data processing that executes a machine learning model configured to detect OOD samples. Uncertainty training and detection system 102 may include one or more computing devices configured to train an ensemble machine learning model to perform detection of OOD data. Uncertainty training and detection system 102 may include one or more computing devices configured to use a trained ensemble machine learning model to detect OOD data. Uncertainty training and detection system 102 may include software instructions for building and/or training one or more machine learning models (e.g., an ensemble machine learning model) for detecting OOD data given at least one runtime input. Uncertainty training and detection system may include at least one storage device configured to store training datasets for building and/or training an ensemble machine learning model that may include at least two machine learning models.

A system configured for automated data processing, that executes a machine learning model configured to detect OOD samples, may include at least one processor programmed or configured to modify at least one training dataset based on mutual information extracted from an ensemble machine learning model to provide at least one adversarial training dataset having a modified measure of epistemic uncertainty. Uncertainty training and detection system 102 may modify (e.g., via processor 106) at least one training dataset based on mutual information extracted from an ensemble machine learning model (e.g., at least two machine learning models) to provide at least one adversarial training dataset having a modified measure of epistemic uncertainty. For example, uncertainty training and detection system 102 may modify at least one data file of the at least one training dataset using mutual information extracted from ensemble machine learning model 112.

A system configured for automated data processing, that executes a machine learning model configured to detect OOD samples, may include at least one processor programmed or configured to execute at least two machine learning models of an ensemble machine learning model. Uncertainty training and detection system 102 may execute (e.g., via processor 106) at least two machine learning models of an ensemble machine learning model for training the at least two machine learning models and/or for generating at least one signal output (e.g., a prediction) of the ensemble machine learning model. For example, uncertainty training and detection system 102 may execute, via processor 106, MLM 110-1 and MLM 110-2 of ensemble machine learning model 112 when training MLM 110-1, MLM 110-2, and/or ensemble machine learning model 112. Uncertainty training and detection system 102 may execute, via processor 106, MLM 110-1 and MLM 110-2 of ensemble machine learning model 112 when generating a signal output (e.g., a prediction) based on a runtime input to ensemble machine learning model 112.

A system configured for automated data processing, that executes a machine learning model configured to detect OOD samples, may include at least one processor programmed or configured to train at least two machine learning models with the at least one training dataset by feeding an input or output of one of the at least two machine learning models to the other of the at least two machine learning models. For example, uncertainty training and detection system 102 may train (e.g., via processor 106) at least two machine learning models with at least one training dataset through dependent training. Uncertainty training and detection system may train, via processor 106, train MLM 110-1 and MLM 110-2 with at least one training dataset by feeding an input or output of MLM 110-1 as an input to MLM 110-2 and by feeding an input or output of MLM 110-2 as an input to MLM 110-1 for training ensemble machine learning model 112.

A system configured for automated data processing, that executes a machine learning model configured to detect OOD samples, may include at least one processor programmed or configured to train the ensemble machine learning model with the at least one adversarial training dataset to provide a trained ensemble machine learning model. Uncertainty training and detection system 102 may train (e.g., via processor 106) the ensemble machine learning model with at least one adversarial training dataset to train the ensemble machine learning model to detect OOD data samples. For example, uncertainty training and detection system 102 may train, via processor 106, ensemble machine learning model 112 (through MLM 110-1 and MLM 110-2) using an adversarial training data such that adversarial data files of the adversarial raining dataset that are perturbed using mutual information cause ensemble machine learning model 112 to learn to more accurately detect OOD data samples that may be input to ensemble machine learning model 112.

A system configured for automated data processing, that executes a machine learning model configured to detect OOD samples, may include at least one processor programmed or configured to receive a runtime input from a client device. Uncertainty training and detection system 102 may receive (e.g., via computing device 104 and/or processor 106) a runtime input from a client device. For example, uncertainty training and detection system 102 may receive a runtime input from a client device that is remote to uncertainty training and detection system 102, where uncertainty training and detection system 102 may execute on a server or a computing device separate from the client device. Client device may receive one or more inputs from a user for transmitting the runtime input to uncertainty training and detection system 102.

A system configured for automated data processing, that executes a machine learning model configured to detect OOD samples, may include at least one processor programmed or configured to provide the runtime input to the trained ensemble machine learning model to generate a signal output (e.g., a prediction) that the runtime input to the trained ensemble machine learning model includes an out-of-distribution sample. Uncertainty training and detection system 102 may (e.g., via processor 106) provide the runtime input to the trained ensemble machine learning model to generate a signal output indicating that the runtime input to the trained ensemble machine learning model includes an out-of-distribution sample. For example, uncertainty training and detection system 102 may provide, via processor 106, the runtime input to ensemble machine learning model 112 such that ensemble machine learning model 112 may generate a signal output indicating that the runtime input includes an OOD data sample. Uncertainty training and detection system 102 may generate a signal output indicating that the runtime input includes an OOD data sample, where ensemble machine learning model 112 detects false positive OOD data samples at a rate of less than or equal to 1% of runtime inputs provided as input to ensemble machine learning model 112.

In some embodiments, the signal output generated by uncertainty training and detection system 102 may be used as an input to processor 106. Processor 106 may be programmed or configured to flag the runtime input, generate an indication that the runtime input is an OOD sample (e.g., via a display device), transmit the runtime input to a client device for further analysis, and/or label the runtime input as an OOD sample such that the runtime input can be stored in proper data sets (e.g., an OOD data set). In some embodiments, processor 106 may be programmed or configured to trigger an alarm and/or other output indication when processor 106 receives the signal output from ensemble machine learning model 112.

In some embodiments, uncertainty training and detection system 102 may be implemented in a single computing device. Uncertainty training and detection system 102 may be implemented in one or more computing devices (e.g., a group of servers, such as a group of computing devices 104, and/or the like) as a distributed system such that software instructions and/or machine learning models are implemented on different computing devices. In some embodiments, uncertainty training and detection system 102 may be associated with computing device 104, such that uncertainty training and detection system 102 is executed on computing device 104 or part of uncertainty training and detection system 102 is executed on computing device 104 as part of a distributed computing system. Alternatively, uncertainty training and detection system 102 may include at least one computing device 104 executing software instructions.

Uncertainty training and detection system 102 may include at least one machine learning model that is trained with an adversarial training dataset. The at least one machine learning model may generate at least one signal output based on adversarial data as a runtime input to the at least one machine learning model. A signal output of the at least one machine learning model may include a prediction (e.g., a determination) whether the adversarial data is OOD data and/or an OOD sample. The at least one machine learning models may be trained on adversarial datasets received by computing device 104 and/or processor 106 from one or more data storage devices (e.g., a database). Additionally or alternatively, the at least one machine learning model may generate at least one signal output (e.g., prediction) based on training and/or testing datasets (e.g., training datasets, adversarial datasets, and/or the like). In some embodiments, output from at least one machine learning model may be used as input for training other machine learning models that are part of malware feature selection system 102.

Computing device 104 may include processor 106 (e.g., CPU) and memory 108. Processor 106 may execute software instructions (e.g., compiled program code) for uncertainty training and detection system 102, including software instructions for at least one ensemble machine learning model and/or at least two machine learning models.

Computing device 104 may include one or more processors (e.g., processor 106) configured to execute software instructions. For example, computing device 104 may include a desktop computer, a portable computer (e.g., laptop computer, tablet computer), a workstation, a mobile device (e.g., smartphone, cellular phone, personal digital assistant, wearable device), a server, and/or other like devices. Computing device 104 may include a computing device configured to communicate with one or more other computing devices over a network. Computing device 104 may include a group of computing devices (e.g., a group of servers) and/or other like devices. In some embodiments, computing device 104 may include a data storage device. Alternatively, a data storage device may be separate from computing device 104 and may be in communication with computing device 104.

Processor 106 may be implemented in hardware, software, or a combination of hardware and software. For example, processor 106 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 may be coupled to memory 108 via a data bus to transfer data between processor 106 and memory 108.

Memory 108 may include random access memory (RAM), read-only memory (ROM), and/or another type of dynamic or static storage device (e.g., flash memory, magnetic memory, optical memory, etc.) that stores information and/or software instructions for use by processor 106. Memory 108 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 108 from another computer-readable medium or from another device via a communication interface with computing device 104. When executed, software instructions stored in memory 108 may cause processor 106 to perform one or more processes described herein. Embodiments described herein are not limited to any specific combination of hardware circuitry and software.

Ensemble machine learning model 112 may include at least two machine learning models (e.g., MLM 110-1, MLM 110-2, etc.). Ensemble machine learning model 112 and MLMs 110 may be trained using unsupervised and/or supervised training methods. Ensemble machine learning model 112 and/or MLMs 110 may be trained with a training dataset and/or an adversarial training dataset received from a data storage device. MLMs 110 may collectively form ensemble machine learning model 112 and may share data (e.g., training data, runtime inputs, outputs, etc.) among the MLMs 110 for training, testing, and/or runtime output (e.g., prediction).

In some embodiments, output from at least one MLM 110 may be used as input to another MLM 110 for training, testing, and/or generating signal outputs (e.g., runtime predictions). For example, ensemble machine learning model 112 may generate a signal output using plural MLMs 110. Each MLM 110 of the plural MLMs 110 may generate a first signal output (e.g., make a first prediction) based on a runtime input to provide plural first signal outputs (e.g., plural first predictions). Each first signal output generated by each of the plural MLMs 110 may be input to a final MLM 110 to generate a final signal output (e.g., a final prediction) based on the plural first signal outputs. In some embodiments, ensemble machine learning model 112 may generate a first signal output with a first MLM 110-1 based on a runtime input. The first signal output may then be an input to a second MLM 110-2 such that MLM 110-2 generates a second signal output (e.g., a second prediction). The second signal output may then be input to a third MLM 110-3 such that MLM 110-3 generates a third signal output (e.g., a third prediction). Various input/output patterns may be used by ensemble machine learning model 112 for any number and/or arrangement of MLMs 110. Ensemble machine learning model 112 may determine any of the signal outputs to be a final signal output, for example, where the final signal output (e.g., final prediction) meets certain criteria of uncertainty training and detection system 102. In some embodiments, ensemble machine learning model 112 may generate plural first signal outputs (e.g., plural first predictions) with plural MLMs 110 and ensemble machine learning model 112 may average and/or count each of the plural first signal outputs to generate a final signal output (e.g., final prediction). In this way, ensemble machine learning model 112 may use various structures and/or input/output patterns of MLMs 110 to generate signal outputs and/or predictions.

In some embodiments, uncertainty training and detection system 102 may generate a signal output (e.g., prediction) using adversarial data as input to ensemble machine learning model 112. Adversarial data may include data that has been perturbed (e.g., attacked) by uncertainty training and detection system 102. Perturbing may refer to one or more techniques of altering data such as adding random variations in a data sample, adding noise to a data sample, and/or causing other small changes in data samples. Data may be perturbed in various ways. In some embodiments, uncertainty training and detection system 102 may perturb image data by altering one or more pixels in the image data. In some embodiments, uncertainty training and detection system 102 may perturb text data by altering one or more words in the text data. Perturbing data may be accomplished by randomly perturbing the data or by targeted perturbing. In this way, uncertainty training and detection system may ensure a robustly trained ensemble machine learning model 112 that may detect an OOD data sample with high accuracy and low false positive detection rates (e.g., FPR≤1%).

In some embodiments, a dataset (e.g., a training dataset, an adversarial dataset, and/or the like) may be input into MLMs 110 and/or ensemble machine learning model 112 for training, testing, and/or production (e.g., runtime signal outputs and/or predictions). In some embodiments, a machine learning model (e.g., ensemble machine learning model 112) may receive a dataset to train the machine learning model. A machine learning model may receive a dataset for testing the machine learning model to evaluate the performance of the machine learning model. In some embodiments, a machine learning model may receive a dataset (e.g., a dataset of runtime inputs) for prediction during a production phase to provide a signal output as an output of the machine learning model (e.g., a runtime signal output and/or prediction).

The number and arrangement of systems, hardware, and/or modules (e.g., software instructions) shown in FIG. 1 is provided as an example. There may be additional systems, hardware, and/or modules, fewer systems, hardware, and/or modules, different systems, hardware, and/or modules, or differently arranged systems, hardware, and/or modules than those shown in FIG. 1. Furthermore, two or more systems, hardware, and/or modules shown in FIG. 1 may be implemented within a single system, hardware, and/or module. A single system, hardware, and/or module shown in FIG. 1 may be implemented as multiple, distributed systems, hardware, and/or modules. Additionally or alternatively, a set of systems, a set of hardware, and/or a set of modules (e.g., one or more systems, one or more hardware devices, one or more modules) of FIG. 1 may perform one or more functions described as being performed by another set of systems, another set of hardware, or another set of modules of FIG. 1.

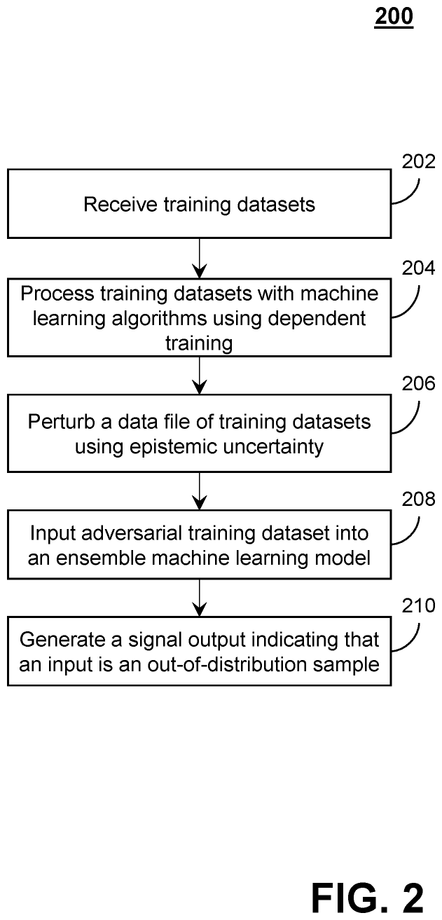

FIG. 2 shows a flow diagram of an exemplary method 200 for automated data processing with a machine learning model configured to detect OOD data as disclosed herein. In some embodiments, one or more of the functions described with respect to method 200 may be performed (e.g., completely, partially, etc.) by uncertainty training and detection system 102 (e.g., via processor 106). In some embodiments, one or more of the steps of method 200 may be performed (e.g., completely, partially, etc.) by another system, hardware, or module or a group of systems, hardware, or modules separate from or including uncertainty training and detection system 102, such as a client device and/or a separate computing device.

In some embodiments, one or more of the steps of method 200 may be performed in a training phase. A training phase may include a computing environment where a machine learning model, such as a neural model, is being trained (e.g., training environment, model building phase, and/or the like). In some embodiments, one or more of the steps of method 200 may be performed in a testing phase. A testing phase may include a computing environment where a machine learning model, such as a neural model, is being tested and/or evaluated (e.g., testing environment, model evaluation, model validation, and/or the like). In some embodiments, one or more of the steps of method 200 may be performed in a runtime phase. A runtime phase may include a computing environment where a machine learning model, such as a neural model, is active (e.g., deployed, accessible as a service, etc.) and is capable of generating runtime signal outputs (e.g., runtime predictions) based on runtime inputs.

As shown in FIG. 2, at step 202, method 200 may include receiving training datasets. For example, computing device 104 and/or processor 106 may receive at least one training dataset. The at least one training dataset may include plural data files. The plural data files may include image files, video files, files including text data, various other data types, and/or a combination thereof. In some embodiments, the plural data files may include at least one clean data file (e.g., a data file that has not been adversarially perturbed and/or is within a distribution of the training dataset).

In some embodiments, uncertainty training and detection system 102 may receive the at least one training dataset as an input to processor 106, while processor 106 is executing uncertainty training and detection system 102. In some embodiments, computing device 104 and/or processor 106 may receive the at least one training dataset from a data storage device.

At step 204, method 200 may include processing training datasets with machine learning algorithms using dependent training. For example, processor 106 may process the at least one training dataset with at least two machine learning algorithms executed by the processor for generating at least two machine learning models (e.g., MLMs 110). In some embodiments, the at least two machine learning algorithms may include at least two convolutional neural networks (CNNs) initialized with random seed weights. For example, nodes of at least two convolutional neural network may be initialized with random weights before the machine learning algorithm is trained.

The at least two machine learning models may be trained by feeding an input and/or output of one of the at least two machine learning models (e.g., MLM 110-1) to the other of the at least two machine learning models (e.g., MLM 110-2) to form an ensemble machine learning model (e.g., ensemble machine learning model 112). In this way, MLMs 110 may be generated by training machine learning algorithms via dependent training, such that the MLMs 110 form ensemble machine learning model 112, providing improved accuracy and performance for detection of OOD data over individual, independently trained machine learning models.

In some embodiments, uncertainty training and detection system 102 (e.g., via processor 106) may train the at least two machine learning models with the at least one training dataset by dropping out a node in the at least two machine learning algorithms. For example, training at least two machine learning algorithms may include randomly dropping one or more nodes in an input layer and/or at least one hidden layer in a neural network (e.g., a CNN).

In some embodiments, uncertainty training and detection system 102 may determine a cross-entropy loss based on model outputs (e.g., predictions) generated during training and ground truth values when training the at least two machine learning models with the at least one training dataset. For example, uncertainty training and detection system 102 (e.g., via processor 106) may determine a cross-entropy loss by comparing a signal output (e.g., prediction) generated during training based on a training data file as an input with a ground truth value that corresponds to the training data file.

At step 206, method 200 may include perturbing a data file of the at least one training dataset using epistemic uncertainty. For example, processor 106 may perturb at least one data file of the at least one training dataset with mutual information extracted from ensemble machine learning model 112 (e.g., mutual information between MLMs 110) to provide an adversarial training dataset. Processor 106 may perturb the at least one data file with mutual information, for example, by altering at least one element of the at least one data file using a measure of epistemic uncertainty derived from the mutual information. In some embodiments, mutual information may include a measure of statistical dependence between at least two variables. In some embodiments, mutual information may include a measure of reduction in uncertainty for a first variable given a known value of a second variable. For example, mutual information between two variables x and y may be defined by |(x; y)=H(x)−H(x|y), where |(x; y) is the mutual information for x and y, H (x) is entropy for x, and H (x|y) is conditional entropy for x given a known value of y.

In some embodiments, uncertainty training and detection system 102 (e.g., via processor 106) may modify the at least one training dataset based on mutual information extracted from an ensemble machine learning model to provide at least one adversarial training dataset having a modified measure of epistemic uncertainty. For example, uncertainty training and detection system 102 may modify at least one data file of the at least one training dataset using mutual information extracted from ensemble machine learning model 112. In some embodiments, the mutual information may include a measure of epistemic uncertainty for a data file. Modifying (e.g., perturbing, attacking, and/or the like) at least one data file in the at least one training dataset with the mutual information may provide at least one adversarial training dataset having at least one data file with a modified measure of epistemic uncertainty. For example, the adversarial data file may result in a different measure of epistemic uncertainty when a machine learning model is trained using the adversarial data file as an input. In this way, perturbing data files to generate adversarial data files may allow for epistemic uncertainty of a machine learning model to be modified and/or changed.

In some embodiments, when modifying at least one data file of at least one training dataset, uncertainty training and detection system 102 may determine an attack magnitude (e.g., for perturbation and/or modification) by randomly sampling an attack magnitude from a uniform distribution. For example, a uniform distribution may include U(0, ϵₘₐₓ), where ϵₘₐₓ=0.02 and where E is the attack magnitude. In some embodiments, when modifying at least one data file of at least one training dataset, uncertainty training and detection system 102 (e.g., via processor 106) may generate at least one adversarial data file based on the at least one data file of plural datafiles in the at least one training dataset. Uncertainty training and detection system 102 may generate the at least one adversarial data file based on the attack magnitude that is randomly sampled from the normal distribution and the mutual information between at least two machine learning models of the ensemble machine learning model.

In some embodiments, uncertainty training and detection system 102 may generate an adversarial data file defined by:

$${x}^{′} = x - ϵ sign ( {∇}_{x} 𝒰 ( x ) )$$

where x′ is the adversarial data file, x is a data file of the plural data files, ϵ is the attack magnitude, and U(x) is mutual information between at least two machine learning models of ensemble machine learning model 112.

At step 208, method 200 may include inputting the adversarial training dataset into an ensemble machine learning model. For example, processor 106 may input the adversarial training dataset into ensemble machine learning model 112 for training ensemble machine learning model 112 on the adversarial training dataset. In some embodiments, processor 106 may train the ensemble machine learning model with the at least one adversarial training dataset to provide a trained ensemble machine learning model.

In some embodiments, inputting an adversarial training dataset into the ensemble machine learning model may include uncertainty training and detection system 102 determining an uncertainty loss defined by:

$$ℒ ( x , {x}^{′} ) = {ℒ}_{l} ( x ) + {βℒ}_{𝒰} ( x , {x}^{′} )$$

where [symbol] (x, x′) is an uncertainty loss, [symbol] (x) is a cross-entropy loss, β is a weighting factor, and [symbol] (x, x′) is an uncertainty proportion defined by:

$${ℒ}_{𝒰} ( x , {x}^{′} ) = {( \overline{Δ} ( x , {x}^{′} ) - \overline{ϵ} )}^{2}$$

where

$$\overline{ϵ} = \frac{ϵ}{{ϵ}_{max}}$$

and ϵ is an attack magnitude.

At step 210, method 200 may include generating a signal output (e.g., including a prediction) that an input is an OOD sample (e.g., an OOD data sample). For example, ensemble machine learning model 112 (e.g., via processor 106) may generate a signal output based on a runtime input to ensemble machine learning model 112. Uncertainty training and detection system 102 may generate the signal output by causing processor 106 to execute a trained ensemble machine learning model (e.g., ensemble machine learning model 112 trained using an adversarial training dataset) with the runtime input. The signal output may indicate (e.g., the signal output may include a determination) that the runtime input is an OOD data sample. For example, the indication may include a flag indicating that the runtime input is an OOD sample, and/or the indication may include a classification of the runtime input (e.g., a classification as “an OOD sample” or “not an OOD sample”). In some embodiments, uncertainty training and detection system 102 (e.g., via processor 106) may receive a runtime input from a client device (e.g., client device 306) or a data storage device (e.g., data storage device 308).

Uncertainty training and detection system 102 (e.g., via processor 106) may generate a trained ensemble machine learning model. Uncertainty training and detection system 102 may train ensemble machine learning model 112 with an adversarial training dataset to generate a trained ensemble machine learning model 112. The trained ensemble machine learning model 112 may detect false positives of OOD data samples no greater than (e.g., less than or equal to) one percent of a total number of runtime inputs to the trained ensemble machine learning model. For example, trained ensemble machine learning model 112 may correctly indicate (e.g., determine and/or predict) that a runtime input is an OOD data sample for at least 99% of the signal outputs (e.g., predictions) that indicate the runtime input is an OOD sample. 1% or less of the runtime inputs fed to trained ensemble machine learning model 112 may be indicated to be OOD data samples incorrectly (e.g., the runtime input is not an OOD data sample, but trained ensemble machine learning model 112 generated a signal output indicating that the runtime input includes an OOD data sample).

In this way, ensemble machine learning model 112 may possess higher accuracy for generating signal outputs (e.g., predictions) indicating that a runtime input includes an OOD sample. Ensemble machine learning model 112 may generate a signal output indicating that the runtime input is an OOD sample as a false positive indication and/or prediction less than or equal to 1% of all signal outputs generated by ensemble machine learning model 112. Training ensemble machine learning model 112 using adversarial training datasets perturbed with epistemic uncertainty measures (e.g., mutual information), as well as the ensemble structure of ensemble machine learning model 112 allow for ensemble machine learning model 112 to correctly indicate and/or predict inputs as OOD samples with high accuracy (e.g., ensemble machine learning model 112 may correctly classify the runtime input as an OOD sample or not an OOD sample with over 99% accuracy).

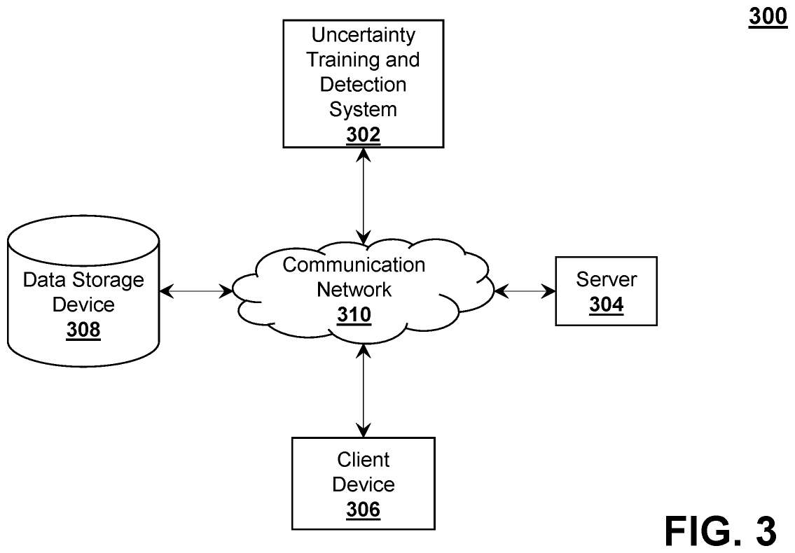

FIG. 3 shows a diagram of an exemplary system environment 300 for automated data processing with a machine learning model configured to detect OOD data as disclosed herein. The various components of FIG. 3 may be implemented in one or more computing devices (e.g., one or more servers, client devices, user devices, and/or the like) and the one or more computing devices may be connected via a communications network (e.g., the Internet). Each of the components shown in FIG. 3 are described in the context of an exemplary embodiment.

As shown in FIG. 3, embodiments relate to a system environment 300 configured for automated data processing with a machine learning model configured to detect inputs as OOD data in which devices, systems, methods, and/or products described herein may be implemented. System 300 may include uncertainty training system 302, server 304, client device 306, data storage device 308, and communication network 310. Uncertainty training and detection system 302, server 304, client device 306, and data storage device 308 may interconnect (e.g., establish a connection to communicate, and/or the like) via wired connections, wireless connections, or a combination of wired and wireless connections.

Uncertainty training and detection system 302 may include one or more computing devices configured to communicate with server 304, client device 306, and/or data storage device 308 via communication network 310. In some embodiments, uncertainty training and detection system 302 may include one or more computing devices such as server 304, client device 306, and/or data storage device 308. For example, uncertainty training and detection system 302 may include a group of servers 304 and/or other like devices. In some embodiments, uncertainty training and detection system 302 may be associated with (e.g., operated by) client device 306, as described herein. In some embodiments, uncertainty training and detection system 302 may be the same as or similar to uncertainty training and detection system 102.

In some embodiments, uncertainty training and detection system 302 may include at least two machine learning models. The at least two machine learning models may be trained using unsupervised and/or supervised training methods. In some embodiments, the at least two machine learning models may be trained using datasets received from data storage device 308. Additionally or alternatively, the at least two machine learning models may provide a signal output including at least one prediction based on testing and/or production (e.g., runtime) datasets received from data storage device 308. In some embodiments, outputs from one machine learning model may be used as input for training other machine learning models that are part of uncertainty training and detection system 302.

Server 304 may include one or more computing devices, such as processors, storage devices, and/or similar computer components that communicate with client device 306 and/or other computing devices over a network, such as the Internet or private networks and, in some examples, facilitate communication among other servers 304 and/or client devices 306. In some embodiments, server 304 may include and/or execute uncertainty training and detection system 302.

Client device 306 may include one or more computing devices configured to communicate with uncertainty training and detection system 302 and/or data storage device 308 via communication network 310. For example, client device 306 may include a desktop computer (e.g., a client device that communicates with a server), a mobile device, and/or the like. In some embodiments, client device 306 may be associated with a user (e.g., an individual operating client device 306). Client device 306 may access a service (e.g., a cloud service, software-as-a-service, and/or the like) such as uncertainty training and detection system 302 made available by server 304.

Data storage device 308 may include one or more datasets used for training and one or more machine learning models. In some embodiments, data storage device 308 may include one or more static training datasets and/or one or more adversarial and/or runtime training datasets. For example, data storage device 308 may include adversarial and/or runtime training datasets which may be continually updated by perturbing data in one or more datasets. In some embodiments, data storage device 308 may include static training datasets which have been previously compiled and stored in data storage device 308. Data storage device 308 may be updated with new and/or adversarial data via communication network 310. Data storage device 308 may be configured to communicate with uncertainty training and detection system 302 and/or client device 306 via communication network 310. In some embodiments, data storage device 308 may be updated with new and/or adversarial data (e.g., inputs and/or outputs) from one or more machine learning models of uncertainty training and detection system 302. For example, output from one or more machine learning models may be communicated to data storage device 308 for storage. In some embodiments, output from one or more machine learning models stored in data storage device 308 may be used as input to at least one other machine learning model for future training and/or perturbation.

The number and arrangement of systems, hardware, and/or devices shown in FIG. 3 is provided as an example. There may be additional systems, hardware, and/or devices, fewer systems, hardware, and/or devices, different systems, hardware, and/or devices, or differently arranged systems, hardware, and/or devices than those shown in FIG. 3. Furthermore, two or more systems, hardware, and/or devices shown in FIG. 3 may be implemented within a single system, hardware, and/or device. A single system, hardware, and/or device shown in FIG. 3 may be implemented as multiple, distributed systems, hardware, and/or devices. Additionally or alternatively, a set of systems, a set of hardware, and/or a set of devices of FIG. 3 may perform one or more functions described as being performed by another set of systems, another set of hardware, or another set of devices of FIG. 3.

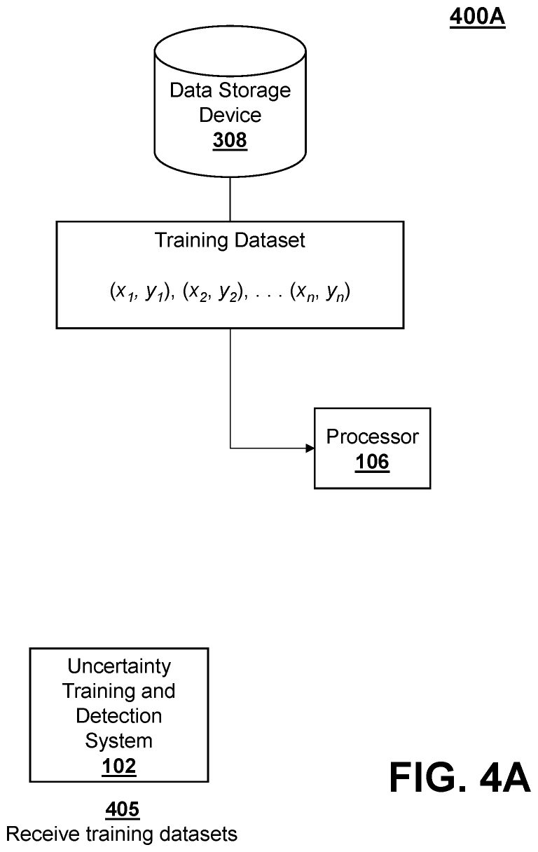

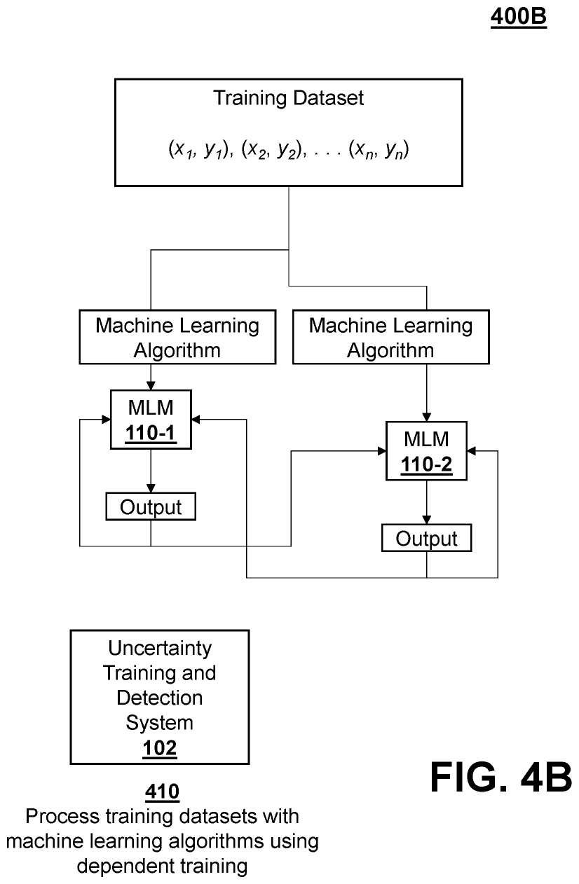

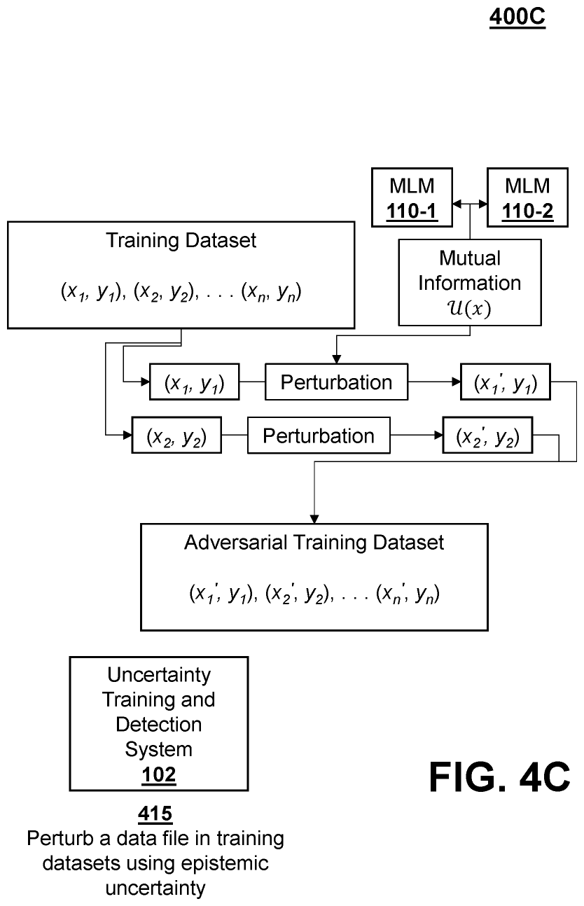

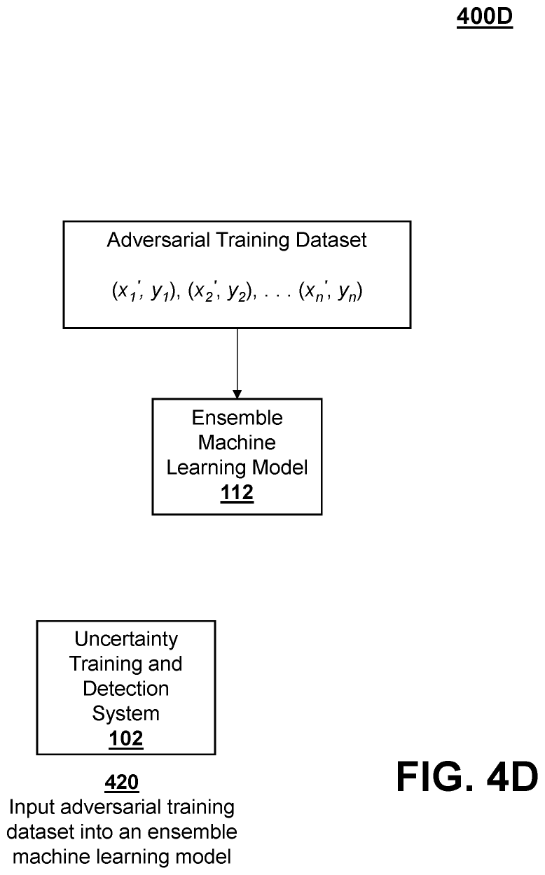

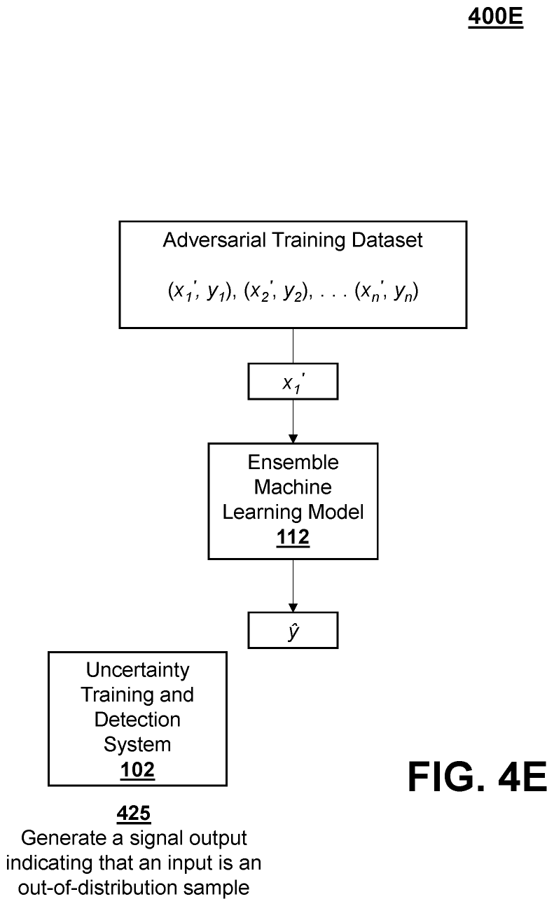

FIGS. 4A-4E are diagrams of an exemplary implementation 400 of an exemplary method (e.g., method 200) for automated data processing with a machine learning model configured to detect OOD data.

As shown by reference number 405 in FIG. 4A, uncertainty training and detection system 102 may receive training datasets. For example, uncertainty training and detection system 102 may receive, via processor 106, a training dataset from data storage device 308. The training dataset may include plural data files, such as a first data file x₁, a second data file x₂, up to a last data file xₙ. Each data file of the plural data files may be associated with a ground truth label (e.g., a target output, a target classification, and/or the like). The ground truth labels may represent a “correct” label, or correct answer that a machine learning model should classify the data file as, and/or a correct indication and/or prediction of the data file. The plural data files and plural ground truth labels are provided to a machine learning model for training such that the machine learning model learns features of each data files and associations of features with the ground truth labels.

In some embodiments, x for each data file may represent a row in a matrix X, where each row represents a data file having one or more features (e.g., columns in matrix X) and y represents a vector of ground truth features (e.g., target features) for which a machine learning model should indicate and/or predict (e.g., generate as signal outputs) once trained using matrix X. Thus, for example, a training dataset may include at least one matrix of feature values and ground truth values associated with the matrix of feature values.

In some embodiments, at least one data file of the plural data files in a training dataset may include an image, text (e.g., alphanumeric text), a video, categorical data, time-series data, tabular data, structured data, and/or any combination thereof. A training dataset may include various types of data, or a training dataset may include data of a single type and/or form. In some embodiments, after receiving a training dataset via processor 106, uncertainty training and detection system 102 may preprocess the plural data files of the training dataset using various methods (e.g., cleaning, aggregating, normalizing, preforming feature selection, and/or the like).

As shown by reference number 410 in FIG. 4B, uncertainty training and detection system 102 may process (e.g., via processor 106) the training datasets with machine learning algorithms using dependent training. For example, uncertainty training and detection system 102 may process the training dataset with at least two machine learning algorithms executed by processor 106 for generating at least two machine learning models (e.g., MLM 110-1 and MLM 110-2). The at least two machine learning models may be trained by feeding an input and/or output of one of the at least two machine learning models to the other of the at least two machine learning models to form an ensemble machine learning model. A machine learning algorithm may include an artificial neural network (ANN), convolutional neural network (CNN), support vector machine (SVM), random forest, k-means clustering and/or cluster analysis, decision trees, naïve bayes, or various other machine learning algorithms. Machine learning models may be generated by training the machine learning algorithms using input data for training.

As shown in FIG. 4B, uncertainty training and detection system 102 may train at least two machine learning algorithms to generate two machine learning models MLM 110-1 and MLM 110-2. In some embodiments, uncertainty training and detection system 102 may train more than two machine learning algorithms to generate more than two machine learning models, up to MLM 110-n. Uncertainty training and detection system 102 may train the at least two machine learning models by feedings inputs and/or outputs of one of the at least two machine learning models to the other of the at least two machine learning models. For example, inputs from the training dataset may be fed to one machine learning model MLM 110-1 or MLM 110-2 or inputs from the training dataset may be fed to both and/or all machine learning models MLM 110-n (e.g., both MLM 110-1 and MLM 110-2). Additionally, outputs from one machine learning model may be input into another machine learning model. For example, outputs from MLM 110-1 may be fed to MLM 110-2 as inputs for training, or other machine learning models MLM 110-n as inputs for training. Outputs from MLM 110-2 may be fed to MLM 110-1 as inputs for training, or other machine learning models MLM 110-n as inputs for training. Uncertainty training and detection system may also use other methods of dependent training for training at least two machine learning models. Uncertainty training and detection system 102 may train the at least two machine learning models to form an ensemble machine learning model (e.g., ensemble machine learning model 112).

As shown by reference number 415, in FIG. 4C, uncertainty training and detection system 102 may perturb a data file from the training dataset using epistemic uncertainty. For example, uncertainty training and detection system 102 (e.g., via processor 106) may perturb at least one data file of the training dataset with mutual information extracted from the ensemble machine learning model (e.g., ensemble of MLM 110-1 and MLM 110-2) to provide an adversarial training dataset. Uncertainty training and detection system 102 may perturb a data file of the training set or plural data files of the training dataset. For example, uncertainty training and detection system 102 may perturb one data file x₁ to generate an adversarial training dataset having at least one adversarial data file x₁. Alternatively, uncertainty training and detection system 102 may perturb more than one data file x₁ to xₙ to generate an adversarial training dataset having plural adversarial data files x₁′ to xₙ′. Each adversarial data file of the adversarial training data (whether the data file was perturbed or not perturbed) may be associated with a ground truth label (e.g., a target output, a target classification, and/or the like). As shown in FIG. 4C, the ground truth labels associated with each data file (including adversarial data files) are represented as y₁ to yₙ.

Uncertainty training and detection system 102 may perturb (e.g., attack) data files of the training dataset by altering at least one aspect of at least one data file. For example, where the plural data files include image files, uncertainty training and detection system 102 may alter pixels (e.g., at least one pixel) of at least one image file to generate an adversarial image file for an adversarial training dataset.

In some embodiments, uncertainty training and detection system 102 may perturb a data file by determining an attack magnitude. An attack magnitude may be selected by randomly sampling an attack magnitude (e.g., a value for the attack magnitude) from a uniform distribution. Uncertainty training and detection system 102 may generate at least one adversarial data file based on the data file by perturbing (e.g., attacking) the data file based on the attack magnitude and the mutual information between at least two machine learning models of ensemble machine learning model 112.

Uncertainty training and detection system 102 may perturb a data file of the training dataset using mutual information derived from training the at least two machine learning models (e.g., MLM 110-1 and MLM 110-2). Mutual information between the at least two machine learning models may include mutual information between a data file in the training dataset and the data file's corresponding ground truth label. For example, mutual information may include a a numeric value representing a measure of how closely related one variable is to another variable. For example, mutual information between a feature of a data file x₁ and a ground truth label y₁ may be based on a probability of an image data file containing a particular color of pixels being classified as an image of a particular object.

In some embodiments, mutual information may be based on a Jensen-Shannon divergence. In some embodiments, the mutual information may be defined by

$$𝒰 ( x ) \approx H [ \overline{p} ( y \vert D , x ) ] - \frac{1}{SM} {\sum }_{i = 1}^{S} {\sum }_{j = 1}^{M} H [ {p}_{j} ( y \vert {w}_{i} , x ) ]$$

where U(x) is the mutual information for an ensemble of M machine learning models, M is a number of machine learning models (e.g., MLMs 110) in the ensemble machine learning model (e.g., ensemble machine learning model 112), S is a number of samples of a dropout mask for each machine learning model in M, H is a function of entropy (e.g., a measure of randomness of information processed by a machine learning model), p is an average categorical probability distribution (averaged over all machine learning models M and all dropout samples S), pⱼ(y|wᵢ, x) is a categorical probability distribution generated (e.g., predicted) by a machine learning model j, where wᵢ are fixed weights for a single pass of the dropout mask.

In some embodiments, uncertainty training and detection system 102 may use the mutual information U(x) to perturb at least one data file in the training dataset to generate an adversarial training dataset.

As shown by reference number 420, in FIG. 4D, uncertainty training and detection system 102 may input the adversarial training dataset into an ensemble machine learning model for training. For example, uncertainty training and detection system 102 (e.g., via processor 106) may input the adversarial training dataset into ensemble machine learning model 112 for processor 106 to train ensemble machine learning model 112. In this way, ensemble machine learning model 112 may learn to recognize OOD data samples, whether input data samples are clean data samples, adversarially perturbed samples, garbage samples, or adversarially perturbed garbage samples. In some embodiments, training ensemble machine learning model 112 may include retraining the at least two machine learning models (e.g., MLM 110-1 and MLM 110-2) using various ensemble training techniques.

As shown by reference number 425, in FIG. 4E, uncertainty training and detection system 102 may generate a signal output (e.g., prediction) that an input to the ensemble machine learning model is an OOD data sample. For example, uncertainty training and detection system 102 (e.g., via processor 106) may generate a signal output by causing processor 106 to execute a trained ensemble machine learning model 112 with a runtime input. The signal output may indicate (e.g., may include a determination) that the runtime input provided to ensemble machine learning model 112 is an OOD data sample.

An OOD data sample may include a data sample and/or data file that may be considered to be outside of a domain of training data. For example, an OOD sample may include a data file that is outside of a domain of the training dataset used to train the at least two machine learning models (e.g., MLM 110-1 and MLM 110-2). In some embodiments, an adversarially perturbed data sample may be considered to be an OOD data sample. As an example, in a distribution of data samples including ultrasound images of human tissue, a data sample including an ultrasound image of steel may be considered an OOD sample with respect to the distribution of ultrasound images of human tissue.

As shown in FIG. 4E, the runtime input may be represented by the adversarial data file x₁′. In some embodiments, the runtime input provided to ensemble machine learning model 112 may include an adversarially perturbed sample, a garbage sample, or an adversarially perturbed garbage sample. The signal output (e.g., an indication that the runtime input is or is not an OOD data sample) may be represented by an output prediction and/or output label y.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

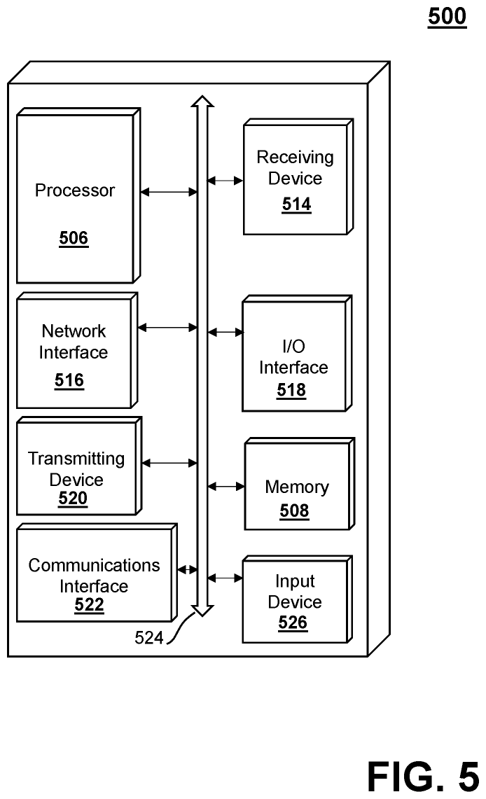

FIG. 5 shows a diagram of example components of a computing device or system 500 as disclosed herein. Computing device 500 (and/or at least one component of computing device 500) may correspond to at least one of uncertainty training and detection system 102, computing device 104, processor 106, and/or memory 108 in FIG. 1 and/or at least one of uncertainty training and detection system 302, server 304, client device 306, data storage device 308, and/or communication network 310 in FIG. 3. In some embodiments, such systems or devices in FIGS. 1-4 may include at least one computing device 500 and/or at least one component of computing device 500. The number and arrangement of components shown in FIG. 5 are provided as an example. In some embodiments, computing device 500 may include additional components, fewer components, different components, or differently arranged components than those shown in FIG. 5. Additionally, or alternatively, a set of components (e.g., one or more components) of computing device 500 may perform one or more functions described as being performed by another set of components of computing device 500.

The computing system or device 500 may include processor 506, memory 508, a receiving device 514, a network interface 516, an input/output (I/O) interface 518, a transmitting device 520, communications interface 522, a communication infrastructure 524, and an input device 526. Memory 508 may be the same as or similar to memory 108 as disclosed herein. Processor 506 may be the same as or similar to processor 106 as disclosed herein. Communications infrastructure 524 may be the same as or similar to communication network 310.

The memory 508 can be configured for storing program code for at least one machine learning model. The memory 508 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 500 via a mobile communication network. According to an exemplary embodiment, an external memory device can be used in place of any resident memory devices. Data stored in system 500 may be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by the processor 506, and software or program code used by the processor 506 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

The receiving device 514 may be a combination of hardware and software components configured to receive data samples from the mobile network or database. According to exemplary embodiments, the receiving device 514 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 514 can be an input device for receiving signals and/or data samples formatted according to 3GPP protocols and/or standards. The receiving device 514 can be connected to other devices via a wired or wireless network or via a wired or wireless direct link or peer-to-peer connection without an intermediate device or access point. The hardware and software components of the receiving device 514 can be configured to receive the data from the mobile network according to one or more communication protocols and data formats. For example, the receiving device 514 can be configured to communicate over a network, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 514 can be configured to identify parts of the received data via a header and parse the data signal and/or data packet into small frames (e.g., bytes, words) or segments for further processing at the processor 506.

The processor 506 can be configured for executing the program code stored in memory 508. Upon execution, the program code causes the processor 506 to perform the functions at a node on the mobile communication network or remote computing device (e.g., server, computer, etc.) of the user and execute a machine learning model (e.g., ensemble machine learning model 112) for OOD sample detection on the mobile communication network according to the exemplary embodiments described herein. The processor 506 can be a special purpose or a general purpose computing device encoded with program code or software for performing the exemplary functions and/or features disclosed herein. According to exemplary embodiments of the present disclosure, the processor 506 can include a CPU. The CPU can be connected to the communications infrastructure including a bus, message queue, or network, multi-core message-passing scheme, for communicating with other components of the computing system 500, such as the memory 508, input device 526, the communications interface 522, and the I/O interface 518. The CPU can include one or more processors such as a microprocessor, microcomputer, programmable logic unit or any other suitable hardware computing devices as desired.

The I/O interface 518 can be configured to receive the signal from the processor 506 and generate an output suitable for a peripheral device via a direct wired or wireless link. The I/O interface 518 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 520 can be configured to receive data from the processor 506 and assemble the data into a data signal and/or data packets according to the specified communication protocol and data format of a peripheral device or remote device to which the data is to be sent. The transmitting device 520 can include any one or more of hardware and software components for generating and communicating the data signal over the communications infrastructure 524 and/or via a direct wired or wireless link to a peripheral or remote device. The transmitting device 520 can be configured to transmit information according to one or more communication protocols and data formats as discussed in connection with the receiving device 514.

According to exemplary embodiments described herein, the memory 508 and the device processor 506 can store and/or execute computer program code for performing the specialized functions described herein. It should be understood that the program code can be stored on a non-transitory computer usable medium, such as the memory devices for the system 500 (e.g., computing device), which may be memory semiconductors (e.g., DRAMs, etc.) or other tangible non-transitory means for providing software to the system 500. The computer programs (e.g., computer control logic) or software may be stored in memory devices (e.g., device memory 508) resident on/in the system 500. The computer programs may also be received from external storage devices and/or network storage locations via a communications interface. Such computer programs, when executed, may enable the system 500 to implement the present methods and exemplary embodiments discussed herein. Accordingly, such computer programs may represent controllers of the system 500. Where the present disclosure is implemented using software, the software may be stored in a computer program product or non-transitory computer readable medium and loaded into the system 500 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system 500 to perform the functions disclosed herein. It will be apparent to persons having skill in the relevant art that such processes result in the system 500 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system configured for automated data processing, that executes a machine learning model configured to detect out-of-distribution samples, the system comprising:
at least one data storage device configured to store at least one training dataset; and
at least one processor programmed or configured to:
modify at least one training dataset based on mutual information extracted from an ensemble machine learning model to provide at least one adversarial training dataset having a modified measure of epistemic uncertainty;
execute at least two machine learning models of an ensemble machine learning model;
train at least two machine learning models with the at least one training dataset by feeding an input or output of one of the at least two machine learning models to the other of the at least two machine learning models;
train the ensemble machine learning model with the at least one adversarial training dataset to provide a trained ensemble machine learning model;
receive a runtime input from a client device; and
provide the runtime input to the trained ensemble machine learning model to generate a signal output indicating that the runtime input to the trained ensemble machine learning model includes an out-of-distribution sample.

2. The system of claim 1, wherein a runtime input includes one or more of an adversarially perturbed sample, a garbage sample, and/or an adversarially perturbed garbage sample.

3. The system of claim 1, wherein plural data files include clean data files.

4. The system of claim 1, wherein at least two machine learning algorithms include convolutional neural networks (CNNs) initialized with random seed weights.

5. The system of claim 1, wherein the at least one processor, as configured to train at least two machine learning models with at least one training dataset, is programmed or configured to:
drop out a node in the at least two machine learning algorithms.

6. The system of claim 1, wherein the trained ensemble machine learning model includes a detection rate of false positives no greater than one percent.

7. The system of claim 1, wherein mutual information between at least two machine learning models of the ensemble machine learning model is based on a Jensen-Shannon divergence.

8. The system of claim 1, wherein the at least one processor, as configured to modify at least one training dataset based on mutual information, is programmed or configured to:
determining an attack magnitude by randomly sampling an attack magnitude from a uniform distribution; and
generating at least one adversarial data file based on at least one data file of plural datafiles in at least one training dataset, the attack magnitude, and the mutual information between at least two machine learning models of the ensemble machine learning model.

9. The system of claim 1, wherein the at least one processor, as configured to train at least two machine learning models with the at least one training dataset, is programmed or configured to:
determine a cross-entropy loss based on model predictions and ground truth values.

10. A computer-implemented method for automated data processing, with a machine learning model configured to detect out-of-distribution samples, the method comprising:
receiving, as an input to a processor, at least one training dataset, the at least one training dataset including plural data files;
processing the at least one training datasets with at least two machine learning algorithms executed by the processor for generating at least two machine learning models, wherein the at least two machine learning models are trained by feeding an input or output of one of the at least two machine learning models to the other of the at least two machine learning models to form an ensemble machine learning model;
perturbing at least one data file of the at least one training dataset with mutual information extracted from the ensemble machine learning model to provide an adversarial training dataset;
inputting the adversarial training dataset into the ensemble machine learning model for the processor to train the ensemble machine learning model; and
generating a signal output by causing the processor to execute a trained ensemble machine learning model with a runtime input, wherein the signal output indicates that the runtime input includes an out-of-distribution sample.

11. The computer-implemented method of claim 10, wherein a runtime input includes one or more of an adversarially perturbed sample, a garbage sample, or an adversarially perturbed garbage sample.

12. The computer-implemented method of claim 10, wherein plural data files include clean data files.

13. The computer-implemented method of claim 10, wherein at least two machine learning algorithms include convolutional neural networks (CNNs) initialized with random seed weights.

14. The computer-implemented method of claim 10, wherein processing the at least one training dataset with at least two machine learning algorithms for generating at least two machine learning models includes dropping out a node in the at least two machine learning algorithms.

15. The computer-implemented method of claim 10, wherein the trained ensemble machine learning model includes a detection rate of false positives no greater than one percent.

16. The computer-implemented method of claim 10, wherein mutual information between at least two machine learning models of the ensemble machine learning model is based on a Jensen-Shannon divergence.

17. The computer-implemented method of claim 10, wherein perturbing at least one data file of at least one dataset includes:
determining an attack magnitude by randomly sampling an attack magnitude from a uniform distribution; and
generating at least one adversarial data file based on at least one data file of the plural datafiles, the attack magnitude, and the mutual information between at least two machine learning models of the ensemble machine learning model.

18. The computer-implemented method of claim 17, wherein generating at least one adversarial data file is defined by:
$${x}^{′} = x - ϵ sign ( {∇}_{x} 𝒰 ( x ) )$$
where x′ is the adversarial data file, x is a data file of the plural data files, ϵ is the attack magnitude, and U(x) is mutual information between at least two machine learning models of the ensemble machine learning model.

19. The computer-implemented method of claim 10, wherein inputting an adversarial training dataset into the ensemble machine learning model includes determining an uncertainty loss defined by:
$$ℒ ( x , {x}^{′} ) = {ℒ}_{l} ( x ) + {βℒ}_{𝒰} ( x , {x}^{′} )$$
where [symbol] (x, x′) is the uncertainty loss, [symbol] (x) is the cross-entropy loss, β is a weighting factor, and [symbol] (x, x′) is an uncertainty proportion defined by:
$${ℒ}_{𝒰} ( x , {x}^{′} ) = {( \overline{Δ} ( x , {x}^{′} ) - \overline{ϵ} )}^{2}$$
where
$$\overline{ϵ} = \frac{ϵ}{{ϵ}_{max}}$$
and ϵ is an attack magnitude.

20. A non-transitory computer readable medium encoded with program code for automated data processing with a machine learning model configured to detect out-of-distribution samples, when placed in communicable contact with a computer processor, the program code causing the processor to be configured to perform an operation comprising:
receiving at least one training dataset, the at least one training dataset including plural data files;
processing the at least one training datasets with at least two machine learning algorithms executed by the processor for generating at least two machine learning models, wherein the at least two machine learning models are trained by feeding an input or output of one of the at least two machine learning models to the other of the at least two machine learning models to form an ensemble machine learning model;
perturbing at least one data file of the at least one training dataset with mutual information extracted from the ensemble machine learning model to provide an adversarial training dataset;
inputting the adversarial training dataset into the ensemble machine learning model to train the ensemble machine learning model; and
generating a signal output by executing a trained ensemble machine learning model with a runtime input, wherein the signal output indicates that the runtime input includes an out-of-distribution sample.
